(19) United States
(12) Patent Application Publication
(10) Pub. No.: US 2025/0005606 A1
(43) Pub. Date: Jan. 2, 2025

(54) SYSTEM AND METHOD FOR MANAGING CUSTOMER DIGITAL CONNECTIONS AND ENHANCING ENGAGEMENT AT A RETAIL LOCATION

(71) Applicant: Uknomi, Inc., Dallas, TX (US)

(72) Inventors: Johann Van Der Westhuizen, Dallas, TX (US); Srinivas Guddati, Flower Mound, TX (US); Morne Erasmus, Dallas, TX (US); Pieter Lewis, Cape Town (ZA)

(73) Assignee: Uknomi, Inc., Dallas, TX (US)

(21) Appl. No.: 18/513,608

(22) Filed: Nov. 19, 2023

Related U.S. Application Data
(63) Continuation-in-part of application No. 18/343,677, filed on Jun. 28, 2023.
(63) Continuation-in-part of application No. 18/343,678, filed on Jun. 28, 2023.

(51) Int. Cl. G06Q 30/0201; G06Q 30/0601; H04L 67/306

(52) U.S. Cl. CPC G06Q 30/0201; G06Q 30/0631; H04L 67/306

(57) ABSTRACT

A system and method for managing customer digital connections and enhancing engagement at a retail location. The method includes receiving a plurality of Bluetooth signals that are within range of one or more of a plurality of Bluetooth BLE beacon devices, transmitting a mobile device identifier and the received signal strength indictor for each of the received plurality of Bluetooth signals to a centralized server over a computer network, receiving the mobile device identifier and the received signal strength indictor for each of the received plurality of Bluetooth signals, comparing the digital fingerprint received to the plurality of digital fingerprints stored in the database in order to determine a matching one of the plurality of zones, matching the mobile device identifier with a plurality of customer profiles stored in a database, creating a new anonymous customer profile in the plurality of customer profiles for an unmatched mobile device identifier, and tracking and storing a customer order and a customer preference respectively in a customer order history and a customer preference history associated with one of the plurality of customers.

### RELATED APPLICATIONS

This disclosure is a continuation of U.S. application Ser. No. 18/343,677, filed Jun. 28, 2023, entitled SYSTEM AND METHOD FOR MULTI-LEVEL RECOGNITION AND LOCATION TRACKING WITHIN A PLURALITY OF ZONES, the disclosure of which is hereby incorporated by reference in its entirety and which was filed concurrently with U.S. application Ser. No. 18/343,678, filed Jun. 28, 2023, entitled SYSTEM AND METHOD FOR PREDICTIVE CUSTOMER TRAIT LEARNING AND PERSONALIZATION, which is incorporated herein by reference in its entirety. Any and all applications, if any, for which a foreign or domestic priority claim is identified in the Application Data Sheet of the present application are hereby incorporated by reference in their entireties under 37 CFR 1.57.

### BACKGROUND OF THE INVENTION

### Field of the Invention

The present invention is generally related to digital connections with customers, and more particularly to a system and method for managing customer digital connections and enhancing engagement at a retail location.

### Discussion of the Background

Retail locations often build up a loyal base of customers who repeatedly frequent the location. These locations sometimes utilize reward programs for the purpose of encouraging the customer to return and enhancing their engagement. However, at existing retail locations there does not exist technologies that efficiently and automatically recognize and track customers. The lack of such automated recognition limits the ability of the retail location to track and optimize the operation of the retail, recognize customer trends, and enhance the customer experience at the retail location.

Thus, there currently exist deficiencies in enhancing customer engagement and managing customer digital connections.

### SUMMARY OF THE INVENTION

Accordingly, one aspect of the present invention is to provide a computer program product embodied on a computer readable medium for managing customer digital connections and enhancing engagement at a retail location. The computer program product includes (i) a first computer code for receiving, by a mobile device, a plurality of Bluetooth signals that are within range of one or more of a plurality of Bluetooth BLE beacon devices; (ii) a second computer code for transmitting, by the mobile device, a mobile device identifier and the received signal strength indictor for each of the received plurality of Bluetooth signals to a centralized server over a computer network; (iii) a third computer code for receiving, by the centralized server, the mobile device identifier and the received signal strength indictor for each of the received plurality of Bluetooth signals; (iv) a fourth computer code for comparing, by the centralized server, the digital fingerprint received to the plurality of digital fingerprints stored in the database in order to determine a matching one of the plurality of zones; (v) a fifth computer code for matching the mobile device identifier, by the centralized server, with a plurality of customer profiles stored in a database; (vi) a sixth computer code for creating a new anonymous customer profile in the plurality of customer profiles for an unmatched mobile device identifier; and (vii) a seventh computer code for tracking and storing a customer order and a customer preference respectively in a customer order history and a customer preference history associated with one of the plurality of customers. The centralized server is in communication with a database having a plurality of digital fingerprints and a plurality of customer profiles. A received signal strength indictor is determined for each of the received plurality of Bluetooth signals. The plurality of customer profiles consist of a plurality of registered customer profiles and a plurality of anonymous customer profiles. Each of the plurality of customer profiles are associated with a corresponding plurality of customers. Each of the plurality of customer profiles include a customer order history and a customer preference history.

Another aspect of the present invention is to provide a computer program product embodied on a computer readable medium for managing customer digital connections and enhancing engagement at a retail location. The computer program product includes (i) a first computer code for receiving a plurality of computer vision signals that are within range of one or more of a plurality of camera integrated devices arranged within a plurality of zones at a retail location; (ii) a second computer code for transmitting each of the received plurality of computer vision signals and the unique zone identifier to a centralized server over a computer network; (iii) a third computer code for comparing, by the centralized server, the received computer vision signals to the plurality of computer vision signals stored in the database; (iv) a fourth computer code for matching the received computer vision signals, by the centralized server, with a plurality of customer profiles stored in a database; (v) a fifth computer code for creating a new anonymous customer profile in the plurality of customer profiles for an unmatched mobile device identifier; and (vi) a sixth computer code for tracking and storing a customer order and a customer preference respectively in the customer order history and the customer preference history associated with one of the plurality of customers. Each of the plurality of zones has a unique zone identifier. The centralized server is in communication with a database having a plurality of computer vision signals and a plurality of customer profiles. The plurality of customer profiles consist of a plurality of registered customer profiles and a plurality of anonymous customer profiles. Each of the plurality of customer profiles are associated with a corresponding plurality of customers. Each of the plurality of customer profiles include a customer order history and a customer preference history.

Yet another aspect of the present invention is to provide a method for managing customer digital connections and enhancing engagement at a retail location. The method includes (i) recognizing anonymous customers by means of either a mobile device identification or computer vision incorporating vehicle or facial detection; (ii) tracking customer visit frequency, orders and the service experience (such as wait times); (iii) providing a user interface enabling a staff member at the retail location to personalize and contextualize interactions and other engagements including customer rewards, customer incentives and personalized customer recommendations; (iv) creating or associating a digital connection with a customer, including a new or previously registered loyalty program; and (v) providing digital connected services including automated pay, ordering, rewards and the like.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIGS. 1A-1D are block diagrams illustrating systems for managing customer digital connections and enhancing engagement at a retail location in accordance with an embodiment of the present invention;

FIGS. 2A-2D are flow charts illustrating a method for managing customer digital connections and enhancing engagement at a retail location in accordance with an embodiment of the present invention; and

FIGS. 3A-3I are graphical user interfaces illustrating non-limiting implementations of a method for managing customer digital connections and enhancing engagement at a retail location in accordance with an embodiment of the present invention.

### DETAILED DESCRIPTION THE PREFERRED EMBODIMENTS

Referring now to the drawings, wherein like reference numerals designate identical or corresponding parts throughout the several views, preferred embodiments of the present invention are described.

According to the present invention, a retail location is provided a system having data and tools to facilitate an emotional connection with the customer using intelligence utilizing the customer's visit frequency, preferences, and order history. The system automatically determines the buying patterns of customers to the retail location. These customers are automatically recognized by the present invention. The buying patterns and frequency of visits are determined and stored for these automatically recognized customers. This information is used without limitation to provide a personalized customer experience with the intention of creating an emotional connection with the customer.

According to one embodiment, the system may incorporate without limitation a video camera and image recognition software and/or a customer “digital fingerprint” to identify anonymous customers as they enter the retail location or a drive-thru lane. After identification, the customer's location and experience within the retail location are tracked during their visit. The system, secures the order that the customer placed in point of sale systems and that order is correlated with a specific identified vehicle or person using the accurate zone timing and the order times.

The order history, visit trends and frequency for each of these anonymous customers is analyzed and maintained in a personal profile for the customer. The system uses the derived profile and visit experience data, to generate personalized messages and incentives with the intention of creating an emotional connection with the customer. The system delivers personalized messages to the staff or to the customer via other digital methods.

According to one embodiment, the system incorporates a simple user interface on a digital device to allow retail location staff to capture a customer's name, phone number, and/or other identifying information to migrate an anonymous profile to a known customer profile. A personalized link is generated and sent by the system as a text message to the customer, or a customer specific QR Code on a retail location user interface. Customer either by clicking the link or scanning QR code can complete the registration details and become a registered customer. The registered customer profile is then associated with other capabilities like loyalties and reward programs that are personalized for the customer.

The present invention recognizes and locates a customer using a digital signal fingerprint. According to an embodiment, the system communicates or interacts with a customer's smart phone or similar device having Bluetooth and/or Wi-Fi enabled capabilities. The system automatically recognizes nearby wireless Bluetooth (“BLE”) beacons or Wi-Fi signals. These signals are converted into digital fingerprints which are compared against digital fingerprints previously stored in a database for the purpose of determining a zone in which a customer is located based on the location of the customer's mobile device. Such information is useful in other functionality including without limitation associating this information with a previously registered customer.

Alternatively, the wireless Bluetooth (“BLE”) beacons and Wi-Fi signals may be replaced with camera integrated devices and computer vision signals, respectively. Computer vision signals may include without limitation facial recognition signals, automobile license place recognition signals and the like. According to this alternative embodiment, computer vision software is used by a centralized server to identify registered and anonymous customers by comparing the received computer vision signals with computer vision signals stored in a database in order to match or create a registered or anonymous customer profile. It is understood that any computer vision hardware and software known in the art for the purpose of unique recognition of a person or an automobile may be utilized within the scope of the present invention.

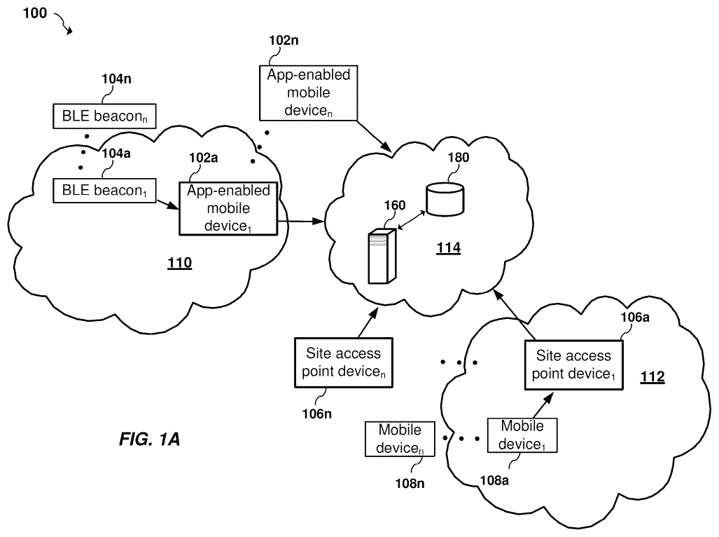

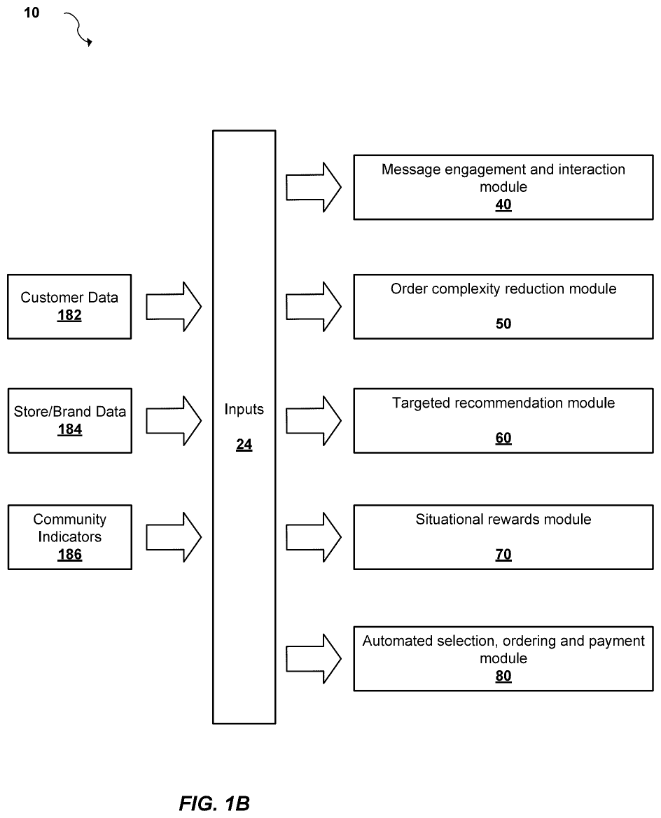

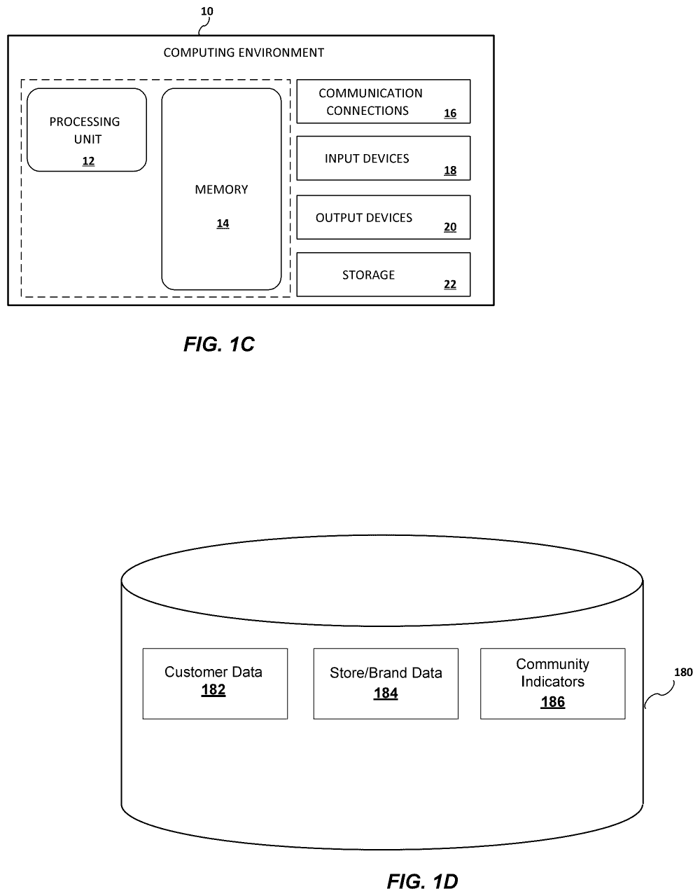

Referring to FIG. 1A, a block diagram illustrating an exemplary system for managing customer digital connections and enhancing engagement at a retail location utilizing multi-level recognition and location tracking within a plurality of zones in accordance with an embodiment of the present invention, is shown. The system may include, without limitation, a centralized server 160 in communication with a database 180.

As used herein, a “mobile device” is a device, such as without limitation a mobile phone, a PDA, laptop computer, tablet or the like, having Wi-Fi and/or Bluetooth capabilities. As used herein, an “app-enabled mobile device” is a device, such as without limitation a mobile phone, a PDA, laptop computer, tablet or the like, having Wi-Fi and/or Bluetooth capabilities and a uknomi app (also referred to as a software application) or an equivalent app installed and running on the device. It is understood, however, that the present invention is not limited to Wi-Fi and/or Bluetooth communication signals and instead other protocols and communication technologies could be utilized known today or not yet existing having similar capabilities within the scope of the present invention.

According to one embodiment, the system includes a plurality of Bluetooth BLE beacons 104a-n geographically distributed at a site location and configured to emit Bluetooth signals. App-enabled mobile devices 102a-n receive the Bluetooth signals from the one or more of these Bluetooth BLE beacons 104a-n within range 110 of the App-enabled mobile devices 102a-n. A received signal strength indicator is determined for each of received the Bluetooth signals by the particular app-enabled device and this information is communicated to the centralized server 160 via a communication network 114, such as without limitation Internet, Intranet or the like.

According to another embodiment, the system includes a plurality of access points 106a-n geographically distributed at a site location and configured to receive signals, including without limitation Wi-Fi and/or Bluetooth signals. Mobile devices 108a-n are typically configured today to automatically emit Wi-Fi and/or Bluetooth signals in search of Wi-Fi routers and/or Bluetooth-enabled devices within range 112 of the particular mobile device 108a-n. A received signal strength indicator is determined for each of received the Wi-Fi and/or Bluetooth signals by the access points 106a-n within range 112 of the mobile device 108a-n and this information is communicated from each of the within range access points 106a-n to the centralized server 160 via a communication network 114, such as without limitation Internet, Intranet or the like.

According to an embodiment, the system communicates or interacts with a software application residing on an app-enabled mobile device in communication with a Bluetooth BLE Beacon, or multiple Bluetooth BLE Beacons, at a fixed location such as without limitation a retail location, store, restaurant, business and/or the like. The app-enabled mobile device includes BLE capabilities that receives a BLE signal transmitted from one or more Bluetooth BLE Beacons. The Bluetooth signal is then used to determine app-enabled mobile device presence and location based on the received signal strength indicator for each of the Bluetooth signals received.

According to an embodiment, the system utilizes a unique pattern matching (“digital fingerprint”) algorithm. One or more Bluetooth BLE Beacons are installed at the location (site) and are configured to emit Bluetooth signals. Any app-enabled mobile device within range of the Bluetooth signals determines its received signal strength indicator and uploads this information is uploaded to a centralized server. A “configuration” algorithm (referred to as the “Site setup Application”) generates a unique pattern (a “digital fingerprint”) for a location based on a numerical combination of received signal strength indicators received by the app-enabled mobile device.

When a “location detection app” on an app-enabled mobile device is within Bluetooth range where one or more Bluetooth BLE beans are installed and active, it begins listening for previously identified devices at that location. With these digital signals, the algorithm communicates the digital signals received signal strength indicators continuously as the app-enabled mobile device moves through the site.

Digital fingerprints associated with the app-enabled mobile device representing its current location are compared against to the digital fingerprints previously stored in a database until a match is determined. Using a confidence factor the application identifies when the app-enabled mobile device is in the pre-determined (saved) locations and notifies the server that the app-enabled mobile device is in that location. This information is then used by other uKnomi functionality to provide personalized engagement with the customer (user of the app-enabled mobile device).

Referring to FIGS. 1B and 1D, block diagrams illustrating systems for managing customer digital connections and enhancing engagement at a retail location in accordance with a embodiment of the present invention, is shown. As shown in FIG. 1B, the present invention includes without limitation a message engagement module 40, a order complexity reduction module 50, a targeted recommendation module 60, a situational rewards module 70, and an automated selection, ordering and payment module 80. Modules 40-80 receive inputs 24 from customer data 182, store or brand data 184 and community indicators 186. Customer data 182 may include without limitation customer demographics, customer preferences and previous orders. Store data 184 may include without limitation store menu data, store sales data, store promotions data and loyalty or reward data. However, it is understood within the scope of the invention that if the store is affiliated with a brand then the store data 184 may be cumulative data of multiple stores in a region and/or all stores within the brand. In this context the store data 184 would be referred to as the brand data 184. The present invention utilizes external signals to learn the tastes and preferences of customers. Community indicators data 186 may include without limitation trend data, social data and weather related data. The learned tastes and preferences of customers are used in the production of curated menus and bespoke order recommendations for each customer. Customer data 182, store or brand data 184 and community indicators data 186 may be store in a database and/or computer memory.

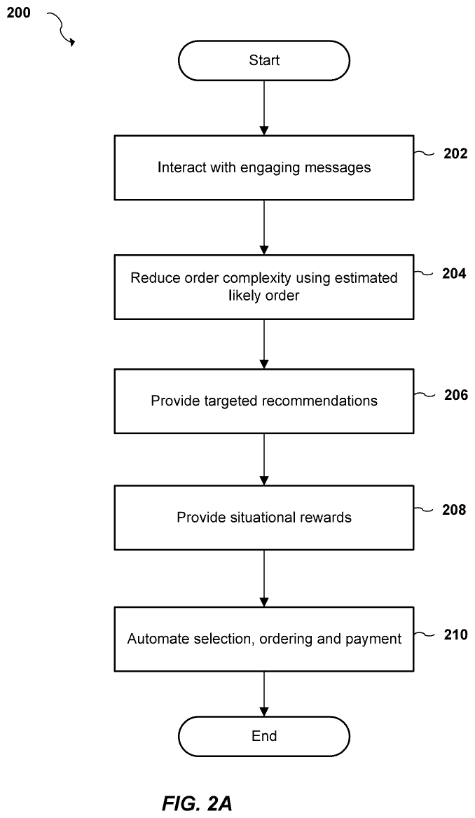

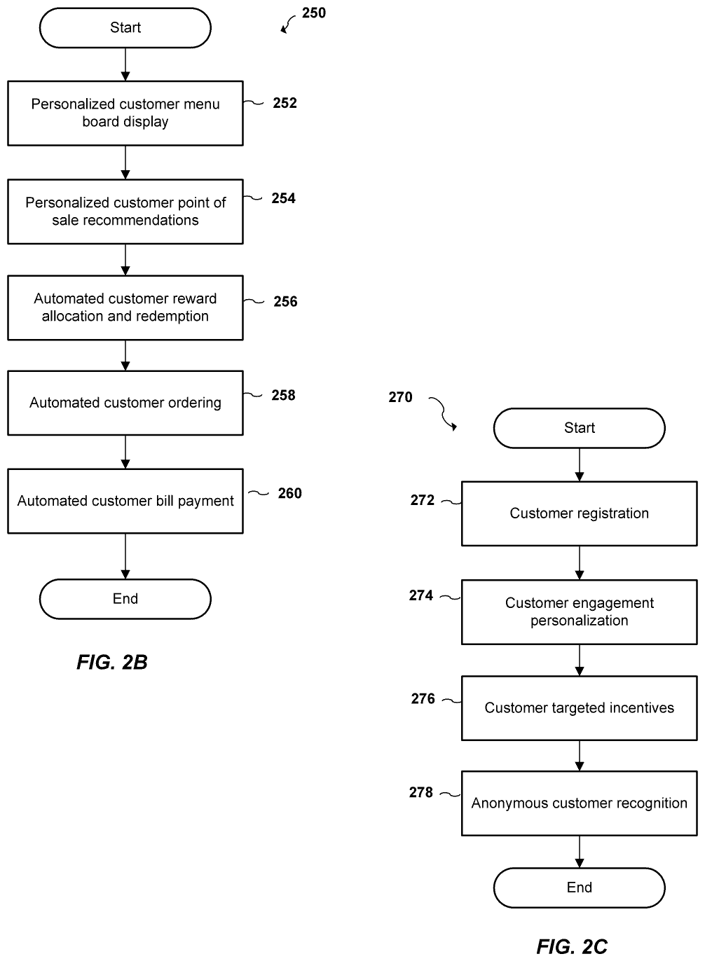

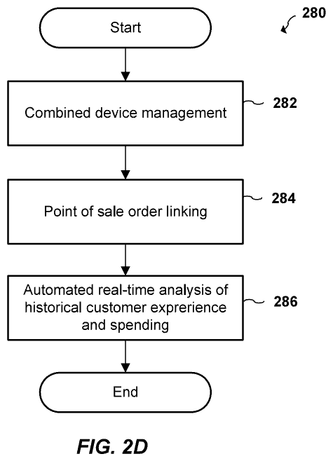

Referring to FIGS. 2A-2D, flow charts illustrating a method for managing customer digital connections and enhancing engagement at a retail location in accordance with an embodiment of the present invention, are shown. As shown in FIG. 2A (200), at block 202, messages are generated to engage and interact with the customer. The order complexity is personalized for the customer by displaying a subset of the menu to the customer, at block 204. The subset of the menu is determined by the system based on an estimated likely order of the customer which is determined by the system using customer data 182, store or brand data 184 and community indicator data 186. At block 206, targeted recommendations are determined and provided to the customer. Situational rewards are provided to the customer at block 208. Blocks 206 and 208 use customer data 182, store or brand data 184 and community indicator data 186 to determine targeted recommendations and situational rewards for the customer. Optionally, at block 210, automated selection, ordering and payment occurs for the customer.

As shown in FIG. 2B (250), at block 252, a personalized customer menu board is displayed to the customer as the customer approaches the menu board in the order zone. The customer is provided personalized point of sale recommendations at block 254. At block 256, personalized customer rewards are automatically allocated to the customer and may be redeemed by the customer. Optionally, the customers order may be automatically entered by the system based on amongst other things historical customer orders at block 258, and the order is automatically paid using previously registered payment methods at block 260.

As shown in FIG. 2C (270), the customer is registered at block 272. Registration may be any known means including the use of a QR code. At block 274, customer engagement is personalized for the particular customer. Customer targeted incentives are provided to either the staff or directly to the customer at block 276. At block 278, customers are anonymously recognized as described in U.S. application Ser. No. 18/343,677.

As shown in FIG. 2D (280), multiple differing devices are combined and coordinated as partially described herein and U.S. application Ser. No. 18/343,677, at block 282. At block 284, the point of sale device is linked to the enhancement system described herein. Automated real-time analysis of historical customer experience and spending occurs at block 286.

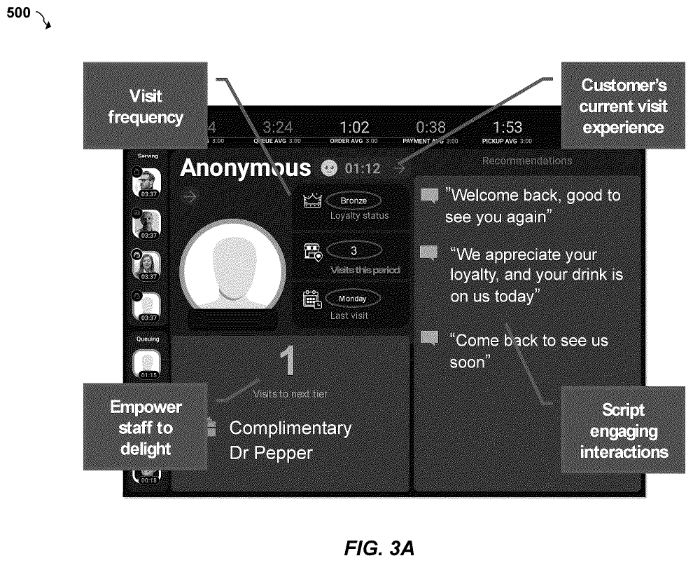

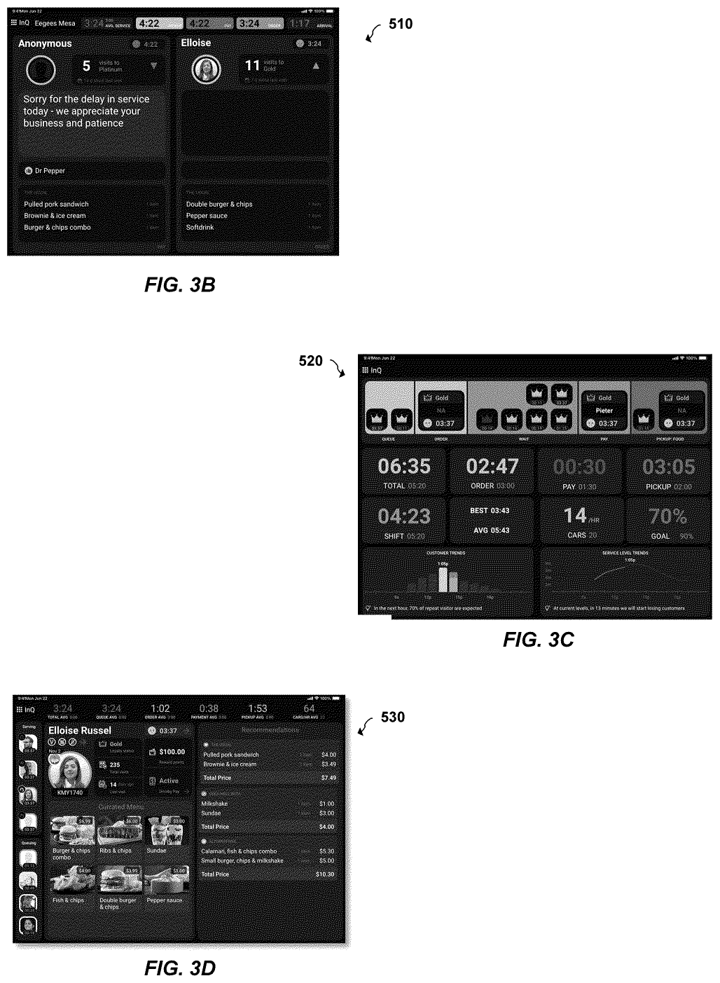

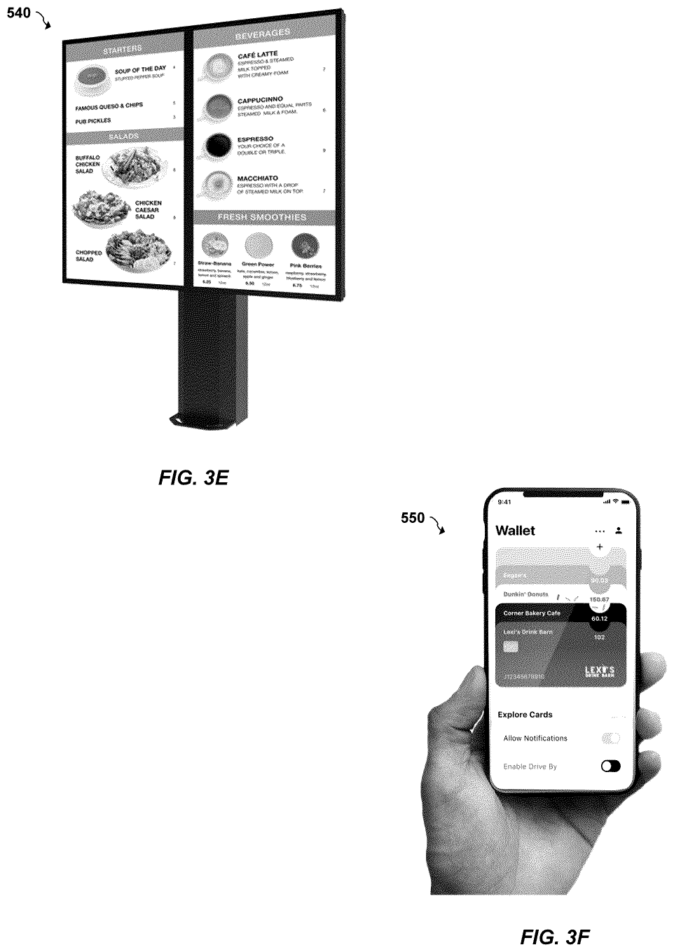

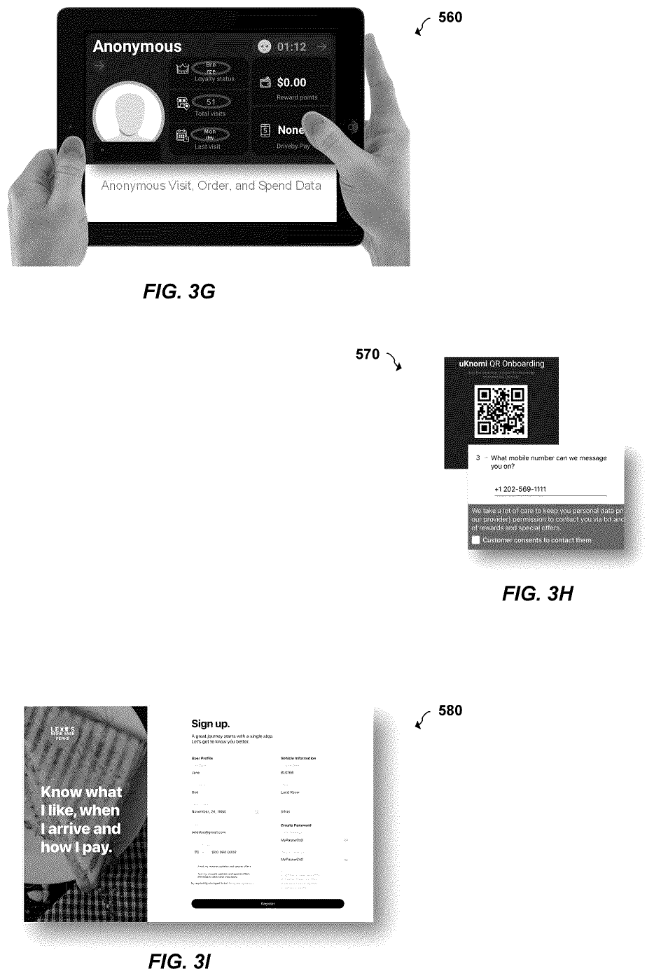

Referring to FIGS. 3A-3I, graphical user interfaces illustrating non-limiting implementations of a method for managing customer digital connections and enhancing engagement at a retail location in accordance with an embodiment of the present invention, are shown. A customer engagement user interface 500 is shown in FIG. 3A, which graphically represents relevant customer engagement information, including without limitation, the customer visit frequency, the interaction engagement script recommendations for the staff, reward level and personalized customer reward information. Additionally, retail location customer visit information relating to the customer's current visit experience, including without limitation, queue duration, order duration, payment duration and pickup duration; each as compared with the average for those durations.

A customer drive engagement user interface 510 is shown in FIG. 3B, which graphically represents relevant customer current visit information, including without limitation, order, pay and pickup information for the customer's current visit to the retail location.

A cumulative customers drive engagement user interface 520 is shown in FIG. 3C, which graphically represents visit information for all current customers cumulatively, including without limitation, the reward levels for each of the current customers in the queue line, order line. waiting line, pay line, and pickup food line. Additionally, cumulative times for order, pay, and pickup, along with customer trends and service level trends are graphically represented.

A customer drive-by pay and personalized recommendations user interface 530 is shown in FIG. 3D, which graphically represents relevant customer current visit pay and recommendations information, including without limitation, order, pay, and pickup information, and personalized order recommendations, for the customer's current visit to the retail location.

A personalized menu board user interface 540 is shown in FIG. 3E, which graphically represents relevant a subset of menu board items and personalized order recommendations, for the customer's current visit to the retail location based on inputs 18 from customer data 182, store or brand data 184 and community indicators 186.

Additionally, a digital wallet user interface 550 is shown in FIG. 3F, which graphically represents digital wallet payment information; an in-queue user interface 560 is shown in FIG. 3G, which graphically represents customer data to identify prospects, along with showing customer visit frequency and trends; a customer scan QR code user interface 570 is shown in FIG. 3H, which graphically represents QR code used to register customer information for enhanced services; and a customer onboarding user interface 580 is shown in FIG. 3I, which graphically represents customer registration information.

As shown in FIG. 1C, the present invention includes a computer program product which may be hosted on a computer-usable storage medium 14 having computer-usable program code embodied in the medium and includes instructions which perform the processes set forth in the present specification on a processing unit 12. The storage medium 14 may include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions. The computing environment may also include, without limitation, communication connections 16, input devices 18, output devices 20 and storage 22.

Computer program code for carrying out operations of the present invention may be written in any programming language including without limitation, object oriented programming languages such as Java®, Smalltalk, C #or C++, conventional procedural programming languages such as the “C” programming language, visually oriented programming environments such as VisualBasic, and the like.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A computer program product embodied on a computer readable medium for managing customer digital connections and enhancing engagement at a retail location, the computer program product comprising:
a first computer code for receiving, by a mobile device, a plurality of Bluetooth signals that are within range of one or more of a plurality of Bluetooth BLE beacon devices, wherein a received signal strength indictor is determined for each of the received plurality of Bluetooth signals;
a second computer code for transmitting, by the mobile device, a mobile device identifier and the received signal strength indictor for each of the received plurality of Bluetooth signals to a centralized server over a computer network;
a third computer code for receiving, by the centralized server, the mobile device identifier and the received signal strength indictor for each of the received plurality of Bluetooth signals, wherein the centralized server is in communication with a database having a plurality of digital fingerprints and a plurality of customer profiles;
a fourth computer code for comparing, by the centralized server, the digital fingerprint received to the plurality of digital fingerprints stored in the database in order to determine a matching one of the plurality of zones;
a fifth computer code for matching the mobile device identifier, by the centralized server, with a plurality of customer profiles stored in a database, wherein the plurality of customer profiles consist of a plurality of registered customer profiles and a plurality of anonymous customer profiles, each of the plurality of customer profiles are associated with a corresponding plurality of customers, and wherein each of the plurality of customer profiles include a customer order history and a customer preference history;
a sixth computer code for creating a new anonymous customer profile in the plurality of customer profiles for an unmatched mobile device identifier; and
a seventh computer code for tracking and storing a customer order and a customer preference respectively in the customer order history and the customer preference history associated with one of the plurality of customers.

2. The computer program product of claim 1, wherein each of the plurality of zones is selected from one of the group consisting of an entry zone, a curb side zone, an order zone, a payment zone, a pickup zone, and an exit zone.

3. The computer program product of claim 2, further comprising an eighth computer code for providing a subset of menu items on a menu board when the customers is within the order zone, wherein the subset of menu items is based on an order estimate for the customer.

4. The computer program product of claim 2, further comprising an eighth computer code for providing targeted order recommendations when the customers is within the order zone, wherein the targeted order recommendations is based on an order estimate for the customer.

5. The computer program product of claim 1, wherein each of the plurality of customer profiles include a customer visit frequency history.

6. The computer program product of claim 5, further comprising a seventh computer code for tracking and storing a customer visit frequency in the customer visit frequency history associated with one of the plurality of customers.

7. A computer program product embodied on a computer readable medium for managing customer digital connections and enhancing engagement at a retail location, the computer program product comprising:
a first computer code for receiving a plurality of computer vision signals that are within range of one or more of a plurality of camera integrated devices arranged within a plurality of zones at a retail location, wherein each of the plurality of zones has a unique zone identifier;
a second computer code for transmitting each of the received plurality of computer vision signals and the unique zone identifier to a centralized server over a computer network, wherein the centralized server is in communication with a database having a plurality of computer vision signals and a plurality of customer profiles;
a third computer code for comparing, by the centralized server, the received computer vision signals to the plurality of computer vision signals stored in the database;
a fourth computer code for matching the received computer vision signals, by the centralized server, with a plurality of customer profiles stored in a database, wherein the plurality of customer profiles consist of a plurality of registered customer profiles and a plurality of anonymous customer profiles, each of the plurality of customer profiles are associated with a corresponding plurality of customers, and wherein each of the plurality of customer profiles include a customer order history and a customer preference history;
a fifth computer code for creating a new anonymous customer profile in the plurality of customer profiles for an unmatched mobile device identifier; and
a sixth computer code for tracking and storing a customer order and a customer preference respectively in the customer order history and the customer preference history associated with one of the plurality of customers.

8. The computer program product of claim 7, wherein each of the plurality of zones is selected from one of the group consisting of an entry zone, a curb side zone, an order zone, a payment zone, a pickup zone, and an exit zone.

9. The computer program product of claim 8, further comprising a seventh computer code for providing a subset of menu items on a menu board when the customers is within the order zone, wherein the subset of menu items is based on an order estimate for the customer.

10. The computer program product of claim 8, further comprising a seventh computer code for providing targeted order recommendations when the customers is within the order zone, wherein the targeted order recommendations is based on an order estimate for the customer.

11. The computer program product of claim 7, wherein each of the plurality of customer profiles include a customer visit frequency history.

12. The computer program product of claim 11, further comprising a seventh computer code for tracking and storing a customer visit frequency in the customer visit frequency history associated with one of the plurality of customers.

13. The computer program product of claim 7, wherein each of the plurality of customer profiles include a customer experience history.

14. The computer program product of claim 13, further comprising a seventh computer code for tracking and storing a customer experience in the customer experience history associated with one of the plurality of customers.

15. The computer program product of claim 14, further comprising an eighth computer code for providing a user interface enabling a staff member at the retail location to personalize and contextualize interactions to improve the customer experience associated with one of the plurality of customers.

16. The computer program product of claim 14, further comprising an eighth computer code for providing a user interface enabling one or more digital connected services, wherein each of the digital connected service is selected from one of the group consisting of automated customer payment of an order, automated placement of the order, and rewards associated with the order.

17. The computer program product of claim 7, wherein each of the plurality of computer vision signals is selected from one of the group consisting of a facial recognition signal and a automobile license plate recognition signal.
